(19) United States
(12) Patent Application Publication
(10) Pub. No.: US 2025/0303787 A1
(43) Pub. Date: Oct. 2, 2025

(54) VEHICLE WHEEL STRUCTURE

(71) Applicant: TOYOTA JIDOSHA KABUSHIKI KAISHA, Aichi-ken (JP)

(72) Inventor: Tomoyuki ISHIKAWA, Nisshin-shi (JP)

(21) Appl. No.: 19/059,264

(22) Filed: Feb. 21, 2025

(30) Foreign Application Priority Data
Mar. 29, 2024 (JP) 2024-055766

(51) Int. Cl. B60B 7/06

(52) U.S. Cl. CPC B60B 7/065; B60B 7/068; B60B 2360/30

(57) ABSTRACT

A vehicle wheel structure includes a wheel that supports a tire and is assembled to a vehicle, and a wheel cover attached to the wheel. The wheel cover includes a main body, a pair of first and second engaging portions that is provided on the main body in a radial direction of the wheel and engaged with a first engaged portion and a second engaged portion of the wheel, and a restricting portion provided in the radial direction to restrict a displacement of the first engaging portion. The wheel cover attached to the wheel is detached from the wheel by displacing the second engaging portion configured not to be restricted in displacement by the restricting portion.

### CROSS-REFERENCE TO RELATED APPLICATION

This application claims priority to Japanese Patent Application No. 2024-055766 filed on Mar. 29, 2024, incorporated herein by reference in its entirety.

### BACKGROUND

### 1. Technical Field

The present disclosure relates to a vehicle wheel structure.

### 2. Description of Related Art

A conventional cap disclosed in, for example, Japanese Patent No. 6363551 is known. The conventional cap is attached to a wheel by engaging the inner peripheral side and the outer peripheral. In addition, the conventional cap includes a rib for restricting a movement when the cap moves outward in the radial direction due to centrifugal force.

### SUMMARY

These days, a wheel cover or an accessory piece and the like including the above-mentioned cap may be attached to a wheel for the purpose of improving the design and aerodynamic characteristic of the wheel. When the wheel cover is attached to the wheel, the wheel cover is secured such that the wheel cover does not easily fall off the wheel or a movement relative to the wheel is reduced as with the conventional cap described above. In this case, for example, when the wheel cover is detached (removed) from the wheel for repair or replacement, it may not be possible to easily remove the wheel cover.

The present disclosure provides a vehicle wheel structure that can easily detach a wheel cover attached to a wheel.

A vehicle wheel structure of the present disclosure includes a wheel that supports a tire and is assembled to a vehicle, and a wheel cover attached to the wheel. The wheel cover includes a main body, a pair of engaging portions that is provided on the main body in a radial direction of the wheel and engaged with an engaged portion of the wheel, the engaging portions including a first engaging portion and a second engaging portion, and a restricting portion provided in the radial direction to restrict a displacement of the first engaging portion. The wheel cover attached to the wheel is detached from the wheel by displacing the second engaging portion configured not to be restricted in displacement by the restricting portion.

With the vehicle wheel structure of the present disclosure, it is possible to release the engagement between the second engaging portion and the engaged portion by displacing the second engaging portion that is not restricted in displacement by the restricting portion. Accordingly, in the first engaging portion provided in the radial direction, the restriction of the displacement by the restricting portion is released, thereby making it possible to release the engagement between the first engaging portion and the engaged portion and easily detach the wheel cover from the wheel.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram for describing a vehicle wheel structure;

FIG. 2 is a diagram for describing a wheel;

FIG. 3 is an enlarged view for describing engaged portions of the wheel;

FIG. 4 is a diagram for describing a wheel cover;

FIG. 5 is a sectional view for describing attachment of the wheel cover;

FIG. 6 is an enlarged sectional view for describing a first engaging portion of the wheel cover;

FIG. 7 is an enlarged sectional view for describing a second engaging portion of the wheel cover;

FIG. 8 is a sectional view for describing removal of the wheel cover;

FIG. 9 is a diagram for describing a wheel cover according to a modification;

FIG. 10 is a diagram for describing a center engaging portion of the wheel cover of FIG. 9;

FIG. 11 is a diagram for describing a wheel cover according to another modification; and

FIG. 12 is a diagram for describing a second engaging portion of the wheel cover according to another modification.

### DETAILED DESCRIPTION OF EMBODIMENTS

Hereinbelow, a vehicle wheel structure of the present disclosure will be described in detail with reference to the drawings. Note that, in addition to the following embodiment, the present disclosure can be carried out in various modes with various changes and improvements based on the knowledge of those skilled in the art.

### 1. Embodiment

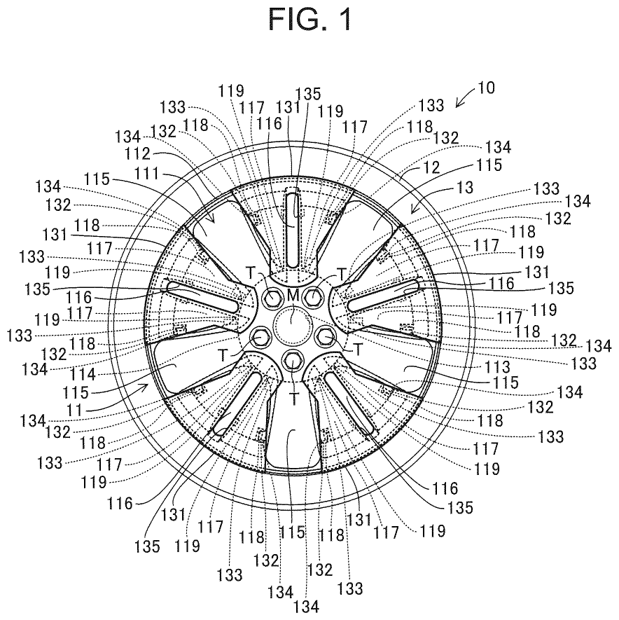

As shown in FIG. 1, a vehicle wheel structure 10 of the present embodiment includes a wheel 11 that constitutes a tire-wheel assembly of a vehicle. The wheel 11 supports a tire 12 and is assembled to the vehicle. The vehicle wheel structure 10 of the present embodiment includes an accessory piece 13 as a wheel cover attached to the wheel 11.

The side on which a vehicle body of the vehicle is located relative to the wheel 11 when the wheel 11 is assembled to the vehicle is defined as the “inner side”, and the opposite side thereof on which the vehicle body is not located is defined as the “outer side”. Note that, in the following description, the “outer side” of the wheel 11 may also be referred to as the “design face”. In addition, in the following description, a direction parallel to a rotation axis passing through the center of the tire-wheel assembly is referred to as the “axial direction”, and a direction perpendicular to the rotation axis of the wheel 11 is referred to as the “radial direction”.

The wheel 11 is made of an alloy such as an aluminum alloy or steel. The wheel 11 includes a disk 111 formed in a disk shape, and an annular rim 112 that is provided on an outer periphery of the disk 111 and holds the tire 12. As shown in FIG. 1, the wheel 11 is assembled to a hub (not shown) of the vehicle with a fastening member T, such as a hub nut or a hub bolt. Note that, the present embodiment shows an example in which the wheel 11 is made of an alloy such as an aluminum alloy, and the disk 111 and the rim 112 are integrally formed as one piece.

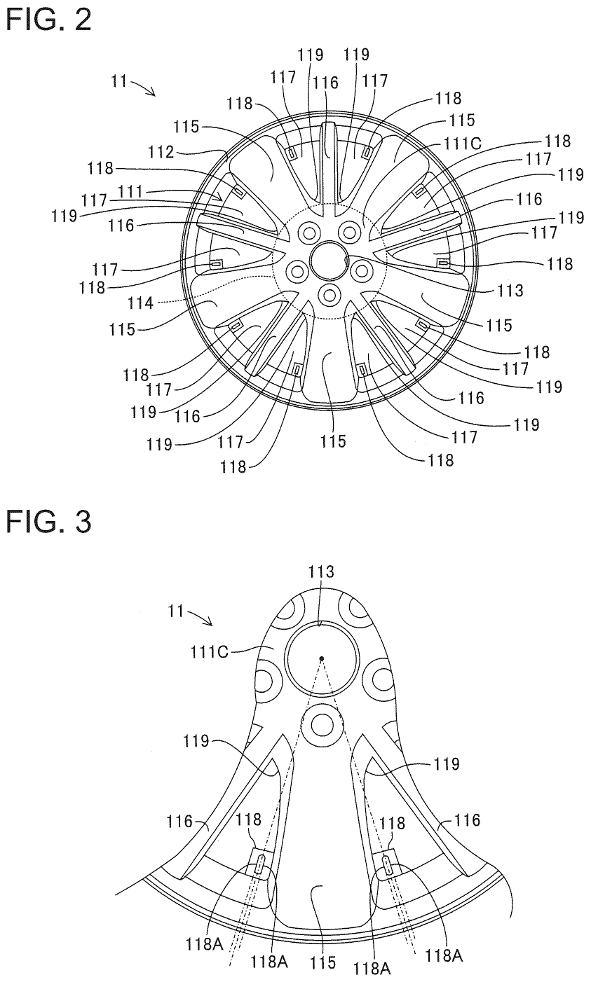

A shown in FIG. 2, the disk 111 has a hub hole 113 that extends in the axial direction and penetrates a central portion 111C of the disk 111. Here, the hub hole 113 can also function as a hole for mounting an ornament M to be provided in the wheel 11 (refer to FIG. 1). Note that, although the present embodiment shows an example in which the hub hole 113 is formed as a through-hole, an end of the hub hole 113 on the design face side may be closed, that is, not open.

As indicated by a broken line in FIGS. 1 and 2, the disk 111 has, on the inner side of the central portion 111C, a hub mounting portion 114 for fixing the wheel 11 to the hub of the vehicle. Note that, although the present embodiment shows an example in which the hub mounting portion 114 has a cylindrical shape, the shape of the hub mounting portion 114 is not limited to a cylindrical shape.

The disk 111 includes, on the outer side, a thick spoke 115 and a thin fin spoke 116 that couple the rim 112 and the hub mounting portion 114 to each other. The present embodiment shows an example in which the disk 111 includes five spokes 115 radially extending from the hub mounting portion 114, and five fin spokes 116 radially extending from the hub mounting portion 114 between the adjacent spokes 115.

The disk 111 has an air hole 117 that is formed between the spoke 115 and the fin spoke 116 that are adjacent to each other and allows air to flow therethrough. The present embodiment shows an example in which, as shown in FIG. 2, the disk 111 has ten air holes 117 each of which is defined by the spoke 115 and the fin spoke 116, the hub mounting portion 114, and the rim 112.

The air hole 117 may be defined, for example, by two spokes 115 and the rim 112, by two fin spokes 116 and the rim 112, or by one spoke 115, one fin spoke 116, and the rim 112 in accordance with the arrangement and the shapes of the spokes 115 and the fin spokes 116. Alternatively, the air hole 117 may be defined, for example, by two spokes 115 and the hub mounting portion 114, or by one spoke 115, one fin spoke 116, and the hub mounting portion 114.

The disk 111 has a first engaged portion 118 as the engaged portion. The first engaged portion 118, for example, has a through-hole having a long hole shape and is engaged with a first engaging portion 132 provided on the accessory piece 13, which will be described further below. The first engaged portion 118 of the present embodiment is provided at a joint between the spoke 115 and the rim 112. Note that, the first engaged portion 118 may, for example, be built in the spoke 115 instead of being provided at the joint between the spoke 115 and the rim 112.

Here, the through-hole of the first engaged portion 118 is formed such that the longitudinal direction is aligned with the radial direction. Thus, the present embodiment shows an example in which the through-hole of the first engaged portion 118 is formed such that a side face 118A of the through-hole is substantially parallel to the radial direction as shown in FIG. 3. This makes it possible to prevent an unnecessary load (stress) from acting on the first engaging portion 132 from the first engaged portion 118, that is, from the through-hole in a state in which the first engaging portion 132 is engaged with the first engaged portion 118 as will be described further below. In addition, in a state in which the accessory piece 13 is attached to the disk 111 of the wheel 11, more specifically, to the air hole 117, over-restraint of the first engaging portion 132 caused by the engagement of a second engaging portion 133, which will be described further below, can be avoided. Note that, the shape and the arrangement of the first engaged portion 118, specifically, the through-hole, are not limited to this.

Furthermore, as shown in FIG. 2, the disk 111 has a second engaged portion 119 as the engaged portion. As shown in FIG. 3 in an enlarged manner, the second engaged portion 119 is substantially aligned with the first engaged portion 118 in the radial direction and engaged with the second engaging portion 133 provided on the accessory piece 13, which will be described further below. Since the first engaged portion 118 is provided at the joint between the tip side of the spoke 115 and the rim 112, the second engaged portion 119 of the present embodiment is provided at a joint between the spoke 115 and the fin spoke 116, more specifically, on the base end side of the spoke 115 such that the second engaged portion 119 is substantially aligned with the first engaged portion 118 in the radial direction.

As shown in FIG. 1, the accessory piece 13 constituting the vehicle wheel structure 10 is configured to cover at least a part of the design face of the wheel 11, the design face being the surface corresponding to the outer side, that is, cover the air hole 117 provided in the wheel 11, and attached to the wheel 11. In other words, the accessory piece 13 is attached to the wheel 11 such that the accessory piece 13 covers at least a part of the surface of the wheel 11 facing outward of the vehicle. Here, the present embodiment shows an example in which five accessory pieces 13 are attached to the wheel 11. Specifically, when two air holes 117 adjacent to each other through the fin spoke 116 in the disk 111 of the wheel 11 is defined as one set, the five accessory pieces 13 are attached to the wheel 11 to cover five sets of air holes 117 that are present in the entire disk 111. Note that, the number of accessory pieces 13 is not limited to five, and may be one or more.

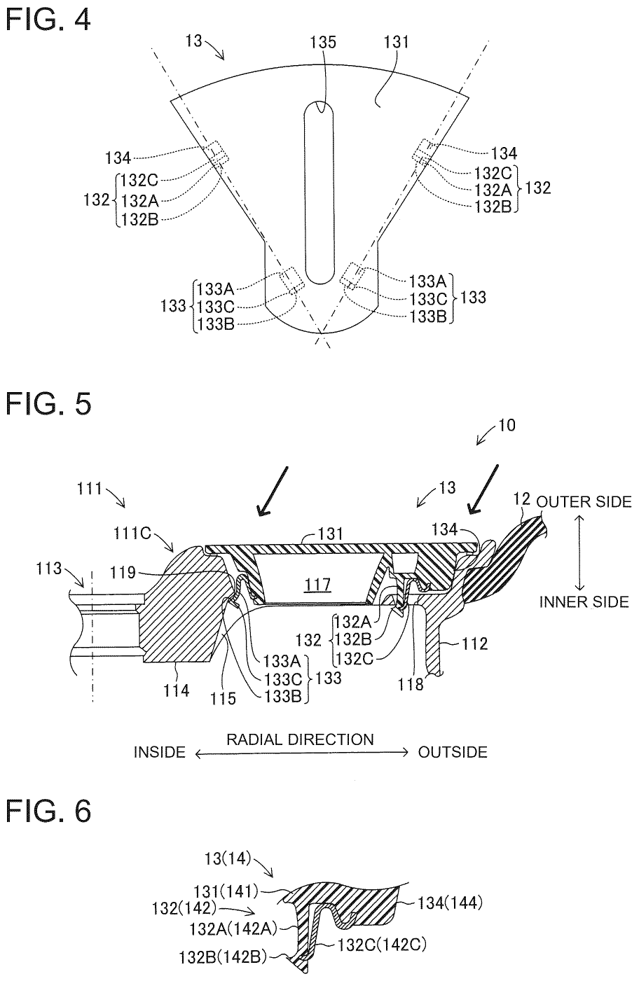

The accessory piece 13 is formed of, for example, a resin material and includes a main body 131 as its main element as shown in FIG. 4. The main body 131 has a plate shape and formed in a fan shape. Note that, the shape of the main body 131 is not limited to a plate shape, and may be, for example, a frame shape. In addition, the shape of the main body 131 is not limited to a fan shape, and various shapes can be adopted in accordance with, for example, the shape of the air hole 117.

The accessory piece 13 has the first engaging portion 132, the second engaging portion 133, and a restricting portion 134 that are provided integrally with the main body 131. Here, as shown in FIG. 4, the first engaging portion 132, the second engaging portion 133, and the restricting portion 134 are arranged along the same line in the radial direction, more specifically, aligned in the same radial direction. With this arrangement, in the present embodiment, the first engaging portion 132 and the second engaging portion 133 serve as a pair of engaging portions that is provided on the main body 131 in the radial direction of the wheel 11 and respectively engaged with the first engaged portion 118 and the second engaged portion 119 that are engaged portions of the wheel 11. Note that, the present embodiment shows an example in which when the first engaging portion 132, the second engaging portion 133, and the restricting portion 134 are defined as one set, two sets are provided in the main body 131.

The first engaging portion 132 is disposed on the side closer to the rim 112 of the wheel 11 and engaged with the first engaged portion 118 provided in the wheel 11 as shown in FIGS. 5 and 6. In other words, the first engaging portion 132 is disposed on the wheel rim side of the accessory piece 13 in the radial direction. The first engaging portion 132 has a leg 132A and a barb 132B. The leg 132A is erected toward the inner side from a back face of the main body 131 with the main body 131 fixed to the disk 111, and supports at its tip side the barb 132B. The barb 132B projects inward in the radial direction at the tip side of the leg 132A and is engaged with the through-hole of the first engaged portion 118.

The first engaging portion 132 is formed of a resin material as with the main body 131. Thus, when the accessory piece 13 is attached to the wheel 11, the first engaging portion 132 is continuously kept in a state in which the first engaging portion 132 is engaged with the through-hole of the first engaged portion 118 to prevent the accessory piece 13 from falling off, that is, the first engaging portion 132 resists an outward force acting on the accessory piece 13 due to air flow, vibrations, and the like. In this case, degradation such as thermal creep or stress relaxation in terms of so-called material characteristics may occur on the first engaging portion 132.

Thus, a backup clip 132C made of thin sheet metal is assembled to the first engaging portion 132. This enables the first engaging portion 132 to have sufficient rigidity, and the first engaging portion 132 engaged with the through-hole of the first engaged portion 118 prevents the accessory piece 13 from falling off.

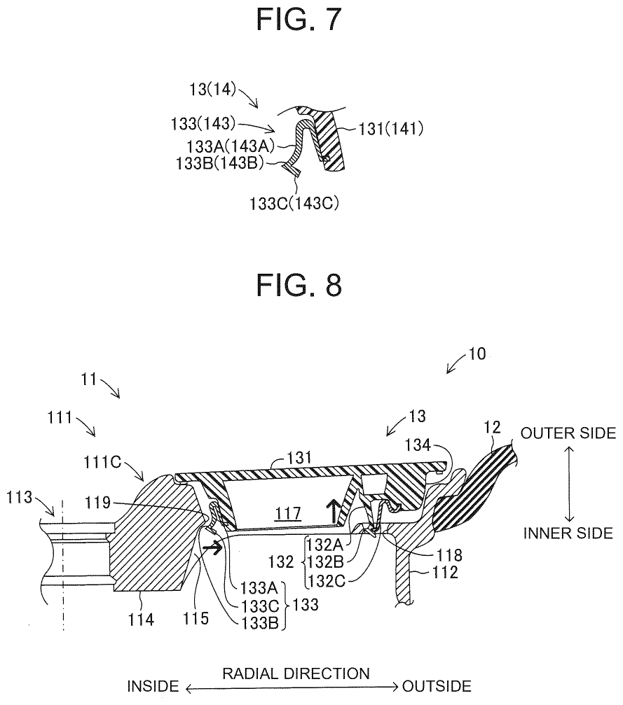

The second engaging portion 133 is disposed on the side closer to the central portion 111C of the wheel 11 and engaged with a step of the second engaged portion 119 provided on the wheel 11 as shown in FIGS. 5 and 7. In other words, the second engaging portion is disposed on the wheel center side of the accessory piece 13 in the radial direction. The second engaging portion 133 is formed of thin sheet metal, and has a main body member 133A, an engaging lug 133B, and a pinching portion 133C. The main body member 133A is formed in a U-shape in cross section such that the main body member 133A can be bent in the radial direction, and is fixed at one side to, for example, a rib provided on the main body 131. Note that, although the present embodiment shows an example in which the cross-sectional shape of the main body member 133A is a U-shape, the cross-sectional shape may be V-shape. The engaging lug 133B projects inward in the radial direction on the other side of the main body member 133A and is engaged with the step of the second engaged portion 119.

Accordingly, in the second engaging portion 133, in a state in which the main body 131 is fixed to the disk 111 of the wheel 11, that is, the accessory piece 13 is attached to the wheel 11, the main body member 133A presses the engaging lug 133B toward the second engaged portion 119 while warping outward in the radial direction. In this state, a reaction force against the pressing force of the main body member 133A of the second engaging portion 133 pressing the engaging lug 133B toward the second engaged portion 119 is transmitted to the restricting portion 134 through the main body 131. Thus, as will be described further below, the restricting portion 134 is pressed against an inner peripheral face of the rim 112 of the wheel 11 due to the transmitted reaction force. Then, the main body 131 is fixed to the wheel 11 by the restricting portion 134 being pressed.

Here, the magnitude of the reaction force against the pressing force described above is set such that the restricting portion 134 is pressed against the inner peripheral face of the rim 112, with the accessory piece 13 attached to the wheel 11. In this case, for example, the magnitude of a gravitational force acting on the accessory piece 13 downward in the vertical direction (that is, from the outside to the inside in the radial direction) at a rotating position of the wheel 11 is also taken into consideration. Accordingly, even when, for example, the vehicle travels at a low speed or travels on a rough road, that is, when the gravitational force larger than the centrifugal force acts on the accessory piece 13 due to the rotation of the wheel 11, the restricting portion 134 is stably pressed against the inner peripheral face of the rim 112.

The pinching portion 133C is provided on the engaging lug 133B and operated to displace the engaging lug 133B when the accessory piece 13 is detached, that is, removed from the disk 111 of the wheel 11 as will be described further below. Thus, the pinching portion 133C, for example, extends outward in the radial direction from the engaging lug 133B so as to be easily pinched with fingers of an operator or a general-purpose tool (such as pliers or pinchers).

Note that, in the present embodiment, the second engaging portion 133 is formed of thin sheet metal. However, as with the first engaging portion 132 described above, the second engaging portion 133 may also be configured, for example, such that the main body member 133A, the engaging lug 133B, and the pinching portion 133C are formed of a resin material and the second engaging portion 133 has a backup clip to ensure sufficient rigidity.

The restricting portion 134 is provided in the radial direction to restrict a displacement of the first engaging portion 132 that is one of the pair of engaging portions, more specifically, an outward displacement in the radial direction caused by the centrifugal force generated when the accessory piece 13 attached to the wheel 11 rotates together with the wheel 11. Thus, the restricting portion 134 is disposed adjacent to the first engaging portion 132 in the radial direction. In the present embodiment, as shown in FIGS. 5 and 6, the first engaging portion 132 and the restricting portion 134 are integrally coupled through the main body 131. That is, in the present embodiment, the main body 131, the first engaging portion 132, and the restricting portion 134 are integrally formed of a resin material.

As shown in FIG. 5, in a state in which the accessory piece 13 is attached to the disk 111 of the wheel 11, that is, a state in which the second engaging portion 133 is engaged with the second engaged portion 119 while pressing the second engaged portion 119 inward in the radial direction, the restricting portion 134 receives the reaction force against the pressing force of the second engaging portion 133 through the main body 131, and the outside of the restricting portion 134 in the radial direction abuts against the inner peripheral face of the rim 112 of the wheel 11. Accordingly, the restricting portion 134 restricts an outward relative movement of the accessory piece 13 in the radial direction. In other words, the restricting portion 134 abuts against the inner peripheral face of the rim 112 of the wheel 11, thereby restricting the accessory piece 13 from moving outward in the radial direction relative to the wheel 11. That is, by restricting the relative movement of the accessory piece 13, the restricting portion 134 also restricts an outward relative movement of the first engaging portion 132 in the radial direction relative to the through-hole of the first engaged portion 118. Accordingly, the restricting portion 134 also restricts the engagement between the first engaging portion 132 and the first engaged portion 118 from being released.

In addition, the accessory piece 13 has a through-hole 135 provided in the main body 131. The through-hole 135 is configured to house a part of the fin spoke 116 constituting the wheel 11, with the main body 131 fixed to the disk 111 of the wheel 11. Note that, although not shown, the accessory piece 13 may have a through-hole that is provided in the main body 131 to allow air passing through the air holes 117 provided in the disk 111 to flow through the through-hole.

Next, attachment and detachment of the accessory piece 13 to and from the wheel 11 will be described. First, the attachment of the accessory piece 13 to the wheel 11 will be described.

In the present embodiment, as shown in FIG. 5, the accessory piece 13 is attached to the air holes 117 formed in the disk 111 of the wheel 11. In this case, for example, the accessory piece 13 is slid into the air holes 117 obliquely from the outside to the inside in the radial direction as indicated by thick solid-line arrows in FIG. 5, while the restricting portion 134 integrated with the main body 131 is kept in abutment against the inner peripheral face of the rim 112 of the wheel 11. Note that, by attaching the accessory piece 13 to the air holes 117 by sliding the accessory piece 13 thereinto in this manner, it is possible, for example, to restrain the first engaging portion 132 and the second engaging portion 133 from damaging the wheel 11.

Then, by sliding the accessory piece 13 obliquely from the outside to the inside in the radial direction, the first engaging portion 132 faces the through-hole of the first engaged portion 118, the barb 132B provided on the tip side of the leg 132A enters the through-hole while the leg 132A is warping outward in the radial direction, and the barb 132B is then engaged with the through-hole of the first engaged portion 118. At this time, the engagement of the barb 132B with the through-hole enables an operator to perceive, for example, a click feeling caused by the barb 132B snapped into the through-hole. The second engaging portion 133 faces the second engaged portion 119, the engaging lug 133B passes through the second engaged portion 119 while the main body member 133A is warping outward in the radial direction, and the engaging lug 133B is then engaged with the step of the second engaged portion 119 (in the present embodiment, the joint between the spoke 115 and the fin spoke 116).

In this manner, in the accessory piece 13 attached to the air holes 117, as described above, the main body member 133A of the second engaging portion 133 presses the second engaged portion 119 inward in the radial direction, the reaction force generated by the pressing is transmitted to the restricting portion 134 through the main body 131, and the restricting portion 134 thus abuts against and presses the inner peripheral face of the rim 112. Thus, the radial position of the accessory piece 13 attached to the air holes 117 is fixed by the pressing force generated by the warpage of the main body member 133A of the second engaging portion 133 and the abutment of the restricting portion 134 against the rim 112.

In the accessory piece 13 attached to the air holes 117, as described above, the abutment of the restricting portion 134 against the rim 112 also restricts the relative movement of the first engaging portion 132 relative to the through-hole of the first engaged portion 118. This maintains a state in the first engaging portion 132 in which the barb 132B is engaged with the through-hole of the first engaged portion 118. In addition, in the first engaging portion 132, the state in which the barb 132B is engaged with the through-hole of the first engaged portion 118 is maintained also by the backup clip 132C pressing the leg 132A and the barb 132B inward in the radial direction.

In the accessory piece 13 attached to the air holes 117, as described above, the engaging lug 133B is pressed toward the second engaged portion 119 by the pressing force caused by the warpage of the main body member 133A. This maintains a state in the second engaging portion 133 in which the engaging lug 133B is engaged with the step of the second engaged portion 119. Thus, the axial position of the accessory piece 13 attached to the air hole 117 is fixed by the engagement between the first engaging portion 132 and the first engaged portion 118 and the engagement between the second engaging portion 133 and the second engaged portion 119, and the accessory piece 13 can be prevented from falling off against an outward force acting on the accessory piece 13 due to air flow, vibrations, and the like during traveling.

Next, a case in which the accessory piece 13 is detached from the wheel 11 will be described. In the present embodiment, for example, when the accessory piece 13 is removed for replacement or repair, first, the wheel 11 assembled to the hub is removed using the fastening member T. Then, an operation of removing the accessory piece 13 is performed from the inner side of the removed wheel 11.

As described above, in a state in which the accessory piece 13 is attached to the air holes 117 of the wheel 11, the second engaging portion 133 and the restricting portion 134 restrict the relative movement of the accessory piece 13 in the radial direction. In addition, in a state in which the accessory piece 13 is attached to the air holes 117 of the wheel 11, the engagement between the first engaging portion 132 and the first engaged portion 118 and the engagement between the second engaging portion 133 and the second engaged portion 119 prevent the accessory piece 13 from moving in the detaching direction.

Thus, in the vehicle wheel structure 10, when the accessory piece 13 is removed from the wheel 11, for example, the engagement between the second engaging portion 133 and the second engaged portion 119 is first released using the pinching portion 133C of the second engaging portion 133. Specifically, an operator, for example, moves the pinching portion 133C outward in the radial direction as indicated by a thick arrow in FIG. 8, using his or her fingers or a general-purpose tool. Accordingly, the engaging lug 133B also moves outward in the radial direction, which releases the engagement with the step of the second engaged portion 119.

When the engagement between the second engaging portion 133 and the second engaged portion 119 is released in this manner, the pressing force of the main body member 133A of the second engaging portion 133 is not generated. As a result, the reaction force transmitted to the restricting portion 134 through the main body 131 is also not generated. That is, the restricting portion 134 pressed against the rim 112 is released and thus dose not restrict the relative movement of the accessory piece 13 in the radial direction.

Thus, as shown in FIG. 8, with the engagement between the second engaging portion 133 and the second engaged portion 119 released, for example, the leg 132A of the first engaging portion 132 is warped outward in the radial direction against the biasing force of the backup clip 132C to release the engagement between the barb 132B and the through-hole of the first engaged portion 118, and a rib of the main body 131 near the first engaging portion 132 is pressed toward the outer side in the axial direction. Accordingly, in the vehicle wheel structure 10, the accessory piece 13 can be easily detached, that is, easily removed from the wheel 11 by releasing the engagement between the second engaging portion 133 and the second engaged portion 119 using the pinching portion 133C.

In addition, in the vehicle wheel structure 10, when the accessory piece 13 is removed from the wheel 11, an operator can first warp the leg 132A of the first engaging portion 132 outward in the radial direction against the biasing force of the backup clip 132C to release the engagement between the barb 132B and the through-hole of the first engaged portion 118. Then, the operator can move the pinching portion 133C outward in the radial direction and press the rib of the main body 31 near the first engaging portion 132 toward the outer side in the axial direction as indicated by thick arrows in FIG. 8, using, for example, his or her fingers or a general-purpose tool. Also in this case, the accessory piece 13 can be easily detached, that is, easily removed from the wheel 11 by releasing the engagement between the second engaging portion 133 and the second engaged portion 119 using the pinching portion 133C.

As can be understood from the above description, the vehicle wheel structure 10 includes the wheel 11 that supports the tire 12 and is assembled to the vehicle, and the accessory piece 13 as the wheel cover attached to the wheel 11. The accessory piece 13 includes the main body 131, the first engaging portion 132 and the second engaging portion 133 as the pair of engaging portions that is provided on the main body 131 in the radial direction of the wheel 11 and engaged with the first engaged portion 118 and the second engaged portion 119 that are the engaged portions of the wheel 11, and the restricting portion 134 that is provided in the radial direction to restrict a displacement of the first engaging portion 132 that is one of the engaging portions. The accessory piece 13 attached to the wheel 11 is detached from the wheel 11 by displacing the second engaging portion 133 that is the other engaging portion that is not restricted in displacement by the restricting portion 134.

In this case, the second engaging portion 133 includes the engaging lug 133B engaged with the second engaged portion 119 as the engaged portion, and the pinching portion 133C operable to displace the engaging lug 133B.

In this case, the first engaging portion 132 is disposed on the side closer to the rim 112 constituting the wheel 11 in the radial direction, and the second engaging portion 133 is disposed on the side closer to the central portion 111C of the wheel 11 in the radial direction.

In this case, the first engaging portion 132 is engaged with the first engaged portion 118 as the engaged portion that is provided in the wheel 11 and has the through-hole.

In this case, the restricting portion 134 is integrally coupled to the first engaging portion 132.

In this case, the restricting portion 134 abuts against the wheel 11 to restrict an outward relative movement of the accessory piece 13 in the radial direction relative to the wheel 11.

With the vehicle wheel structure 10 of the embodiment described above, the engagement between the engaging lug 133B of the second engaging portion 133 and the step of the second engaged portion 119 can be released by displacing the second engaging portion 133 that is not restricted in displacement by the restricting portion 134, more specifically, by displacing the second engaging portion 133 using the pinching portion 133C provided on the engaging lug 133B. Accordingly, in the first engaging portion 132 provided in the radial direction, the restriction of the outward displacement in the radial direction made by the restricting portion 134 is released. As a result, it is possible to release the engagement between the first engaging portion 132 and the through-hole of the first engaged portion 118 and easily detach the accessory piece 13 from the air holes 117 of the wheel 11.

### 2. Modification

In the embodiment described above, the accessory piece 13 to be attached to each air hole 117 is described as an example of the wheel cover. Instead of this, in a modification, a wheel cover 14 that covers the whole of the design face of the wheel 11, the design face being the surface corresponding to the outer side of the vehicle, with the wheel cover 14 attached to the wheel 11 is described as an example of the wheel cover. Note that, as with the accessory piece 13 in the embodiment described above, the wheel cover 14 is also formed of, for example, a resin material.

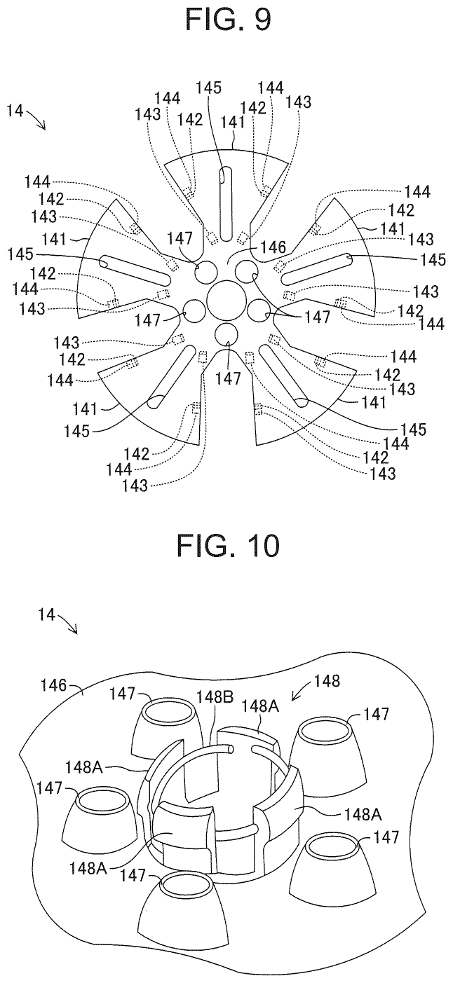

As shown in FIG. 9, the wheel cover 14 includes a main body constituting member 141 corresponding to the main body 131 of the accessory piece 13 in the embodiment described above. Here, also in the modification, the wheel cover 14 is attached to the wheel 11 shown in FIG. 2. Thus, in the modification, the wheel cover 14 includes five main body constituting members 141 corresponding to the five sets of air holes 117 of the wheel 11 described in the embodiment described above.

As with the accessory pieces 13 in the embodiment described above, each of the main body constituting members 141 has a first engaging portion 142, a second engaging portion 143, a restricting portion 144, and a through-hole 145. Here, the first engaging portion 142, the second engaging portion 143, the restricting portion 144, and the through-hole 145 have the same configurations as the first engaging portion 132, the second engaging portion 133, the restricting portion 134, and the through-hole 135 described in the accessory piece 13 of the embodiment described above, respectively. Thus, the description for the configurations of the first engaging portion 142, the second engaging portion 143, the restricting portion 144, and the through-hole 145 will be omitted by adding reference signs in FIGS. 6, 7, and 9.

The wheel cover 14 has a coupling portion 146 that couples each of the main body constituting members 141 in the circumferential direction of the disk 111 at the central portion 111C of the disk 111, with the wheel cover 14 attached to the wheel 11. Accordingly, a plurality of main body constituting members 141 are integrated together by the coupling portion 146, and the wheel cover 14 having a disk shape is attached to the wheel 11 such that the wheel cover 14 covers the entire design face of the disk 111 of the wheel 11.

Here, the modification shows an example in which the coupling portion 146 couples a plurality main body constituting members 141 at the central portion 111C of the disk 111, with the wheel cover 14 attached to the wheel 11. However, for example, it is of course possible for the coupling portion 146 to couple the main body constituting members 141 at a position other than the central portion 111C of the disk 111 in accordance with the shape of the disk 111 of the wheel 11, more specifically, the three-dimensional shapes of the spoke 115 and the fin spoke 116. Also in this case, a plurality main body constituting members 141 are integrated together by the coupling portion 146, and the wheel cover 14 having a disk shape can be attached to the disk 111 of the wheel 11.

The wheel cover 14 has operation holes 147 into which the fastening member T for assembling the wheel 11 to the hub is inserted to enable a fastening operation. Each of the operation holes 147 is a through-hole that is provided in the coupling portion 146 and is formed in the axial direction.

Furthermore, as shown in FIG. 10, the wheel cover 14 has a center engaging portion 148 that is engaged with an annular ridge provided in the hub hole 113. The center engaging portion 148 has center lugs 148A that are fitted with the ridge of the hub hole 113, and a wire ring 148B that biases the center lugs 148A toward the ridge of the hub hole 113. Accordingly, when the wheel cover 14 is attached, the center engaging portion 148 can fix the wheel cover 14 to the wheel 11 (disk 111) by the center lugs 148A and the wire ring 148B being inserted into the hub hole 113 and the center lugs 148A thus being engaged with the ridge of the hub hole 113.

When the wheel cover 14 configured in this manner is attached to the wheel 11, for example, as with the case of the accessory piece 13 described above, the first engaging portion 142 provided on the main body constituting member 141 is engaged with the first engaged portion 118, and the second engaging portion 143 is engaged with the second engaged portion 119, thereby bringing the restricting portion 144 into abutment against the rim 112. Then, substantially simultaneously with fixing each of the main body constituting members 141 to the air holes 117 of the wheel 11, the center engaging portion 148 is pushed into the hub hole 113 in the axial direction and engaged with the hub hole 113, thereby attaching the wheel cover 14 to the wheel 11.

Accordingly, with the disk-shaped wheel cover 14 that covers the entire design face of the wheel 11 attached to the wheel 11, the radial position of the wheel cover 14 is fixed by the pressing force generated by the warpage of the main body member 143A of the second engaging portion 143 and the abutment of the restricting portion 144 against the rim 112 in addition to the engagement between the center engaging portion 148 and the ridge of the hub hole 113. In addition, the axial position of the wheel cover 14 is fixed by the engagement between the first engaging portion 142 and the first engaged portion 118 and the engagement between the second engaging portion 143 and the second engaged portion 119 in addition to the engagement between the center engaging portion 148 and the ridge of the hub hole 113, and the wheel cover 14 can be prevented from falling off against an outward force acting on the wheel cover 14 due to air flow, vibrations, and the like during traveling.

When the wheel cover 14 is detached from the wheel 11, for example, as with the case of the accessory piece 13 described above, first, the wheel 11 assembled to the hub is removed using the fastening member T. Then, an operation of removing the wheel cover 14 is performed from the inner side of the removed wheel 11. Then, when the wheel cover 14 is removed from the wheel 11, for example, first, the engagement between the center engaging portion 148 and the ridge of the hub hole 113 is released. Accordingly, although different from the accessory piece 13 described above in that the main body constituting members 141 are coupled together by the coupling portion 146, the wheel cover 14 is brought into a state in which the first engaging portion 142 and the second engaging portion 143 are engaged with the first engaged portion 118 and the second engaged portion 119 of the wheel 11, respectively.

Thus, also in the modification, as with the case of the accessory piece 13 described above, the engagement between the second engaging portion 143 and the step of the second engaged portion 119 is first released using the pinching portion 143C of the second engaging portion 143. Then, with the engagement between the second engaging portion 143 and the second engaged portion 119 released, for example, the engagement between the barb 142B and the through-hole of the first engaged portion 118 is released, and a rib of the main body constituting member 141 near the first engaging portion 142 is pressed toward the outer side in the axial direction. Note that, also in this case, the engagement between the barb 142B and the through-hole of the first engaged portion 118 may first be released. Then, the engagement between the second engaging portion 143 and the step of the second engaged portion 119 may be released using the pinching portion 143C, and the rib near the first engaging portion 142 may be pressed toward the outer side in the axial direction. Accordingly, also in the vehicle wheel structure 10 in the modification, the wheel cover 14 can be easily detached, that is, easily removed from the wheel 11 by releasing the engagement between the second engaging portion 143 and the second engaged portion 119 using the pinching portion 143C.

Thus, as illustrated in the modification, also when the wheel cover is the wheel cover 14, as with the case of the accessory piece 13 illustrated in the embodiment described above, it is possible to easily remove the wheel cover 14 that is attached in a manner to prevent falling off during normal use. Thus, effects similar to the effects of the embodiment described above can be obtained.

### 3. Other Modifications

In the embodiment and the modification described above, the first engaging portions 132 (first engaging portions 142) are provided on the respective ends of the main body 131 (main body constituting member 141) on opposite sides of the through-hole 135 (through-hole 145), and the second engaging portions 133 (second engaging portions 143) are provided on the respective ends of the main body 131 (main body constituting member 141) on opposite sides of the through-hole 135 (through-hole 145). For example, in an example of the accessory piece 13, when the first engaging portion 132 provided on each end of the main body 31 is engaged with the corresponding first engaged portion 118, in a state in which the accessory piece 13 is attached to the wheel 11, warpage deformation such as lifting is likely to occur in a low-rigidity area around the through-hole 135.

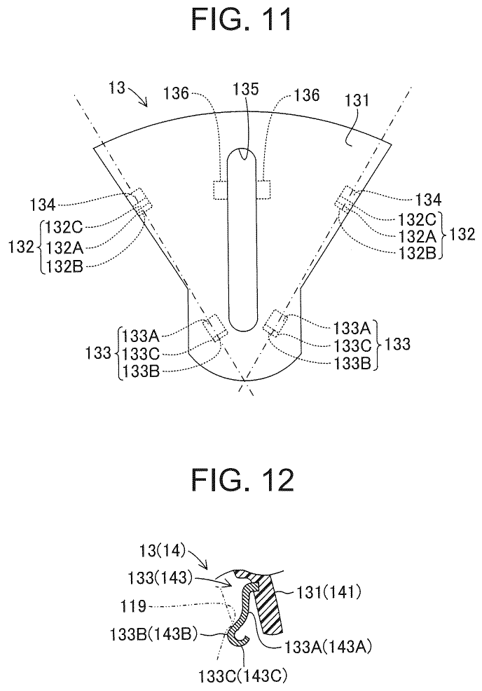

Thus, in the vehicle wheel structure 10, as shown in FIG. 11, sub engaging portions 136 may be provided in the low-rigidity area in the main body 131, that is, in the longitudinal direction of the through-hole 135 having a long hole shape such that the sub engaging portions 136 are engaged holding the fin spoke 116 when fixed to the wheel 11. Accordingly, the sub engaging portions 136 prevent the occurrence of warpage deformation such as lifting in the low-rigidity area in the main body 131, that is, around the through-hole 135. The other effects are substantially the same as those of the embodiment and the modification described above.

The embodiment and the modification described above show an example in which the second engaging portion 133 (second engaging portion 143) has the engaging lug 133B (engaging lug 143B) having a projecting shape projecting inward in the radial direction. In addition, the embodiment and the modification described above show an example in which the end portion of the engaging lug 133B (engaging lug 143B) opposite to the main body member 133A (main body member 143A) serves as the pinching portion 133C (pinching portion 143C). Instead of this, as shown in FIG. 12, the engaging lug 133B (engaging lug 143B) may be formed in an arc shape, a so-called hook shape, and the hook-shaped end portion may serve as the pinching portion 133C (pinching portion 143C). Also in this case, effects similar to the effects of the embodiment and the modification described above can be obtained.

In the embodiment and the modification described above, corresponding to the arrangement of the first engaged portions 118 and the second engaged portions 119 provided in the wheel 11, the first engaging portion 132 (first engaging portion 142), the second engaging portion 133 (second engaging portion 143), and the restricting portion 134 (restricting portion 144) are provided on each of the ends of the main body 131 (main body constituting member 141) on opposite sides of the through-hole 135 (through-hole 145). On the other hand, for example, when the first engaged portion 118 is provided at the joint between the fin spoke 116 and the rim 112, the first engaging portion 132 (first engaging portion 142) and the second engaging portion 133 (second engaging portion 143) may be provided at the central portion of the main body 131 (main body constituting member 141) on each of opposite sides of the through-hole 135 (through-hole 145).

The embodiment and the modification described above show an example in which the fin spoke 116 is provided between the two thick spokes 115 in the wheel 11. However, for example, when the wheel 11 does not include the fin spoke 116, the first engaged portion 118 can be provided in the rim 112 between the spokes 115 that are adjacent to each other in the circumferential direction, for example. Thus, in this case, at the central portion of the main body 131 (main body constituting member 141), one first engaging portion 132 (first engaging portion 142) and one second engaging portion 133 (second engaging portion 143) may be provided.

Furthermore, in the embodiment and the modification described above, with the accessory piece 13 (wheel cover 14) attached to the wheel 11, the restricting portion 134 (restricting portion 144) abuts against the rim 112 constituting the wheel 11 to restrict the outward relative movement of the accessory piece 13 (wheel cover 14) in the radial direction. However, the restricting portion 134 (restricting portion 144) may abut against a member other than the rim 112 of the wheel 11, for example, the spoke 115 or the fin spoke 116 as long as the restricting portion 134 (restricting portion 144) can restrict the outward relative movement of the accessory piece 13 (wheel cover 14) in the radial direction.

Here, a vehicle wheel structure of a first aspect of the present disclosure includes a wheel that supports a tire and is assembled to a vehicle, and a wheel cover attached to the wheel. The wheel cover includes a main body, a pair of engaging portions that is provided on the main body in a radial direction of the wheel and engaged with an engaged portion of the wheel, the engaging portions including a first engaging portion and a second engaging portion, and a restricting portion provided in the radial direction to restrict a displacement of the first engaging portion. The wheel cover attached to the wheel is detached from the wheel by displacing the second engaging portion configured not to be restricted in displacement by the restricting portion.

A vehicle wheel structure of a second aspect of the present disclosure is the vehicle wheel structure of the first aspect in which the second engaging portion includes an engaging lug engaged with the engaged portion, and a pinching portion configured to be operable to displace the engaging lug.

A vehicle wheel structure of a third aspect of the present disclosure is the vehicle wheel structure of the first or second aspect in which the first engaging portion is disposed on a wheel rim side of the wheel cover in the radial direction, and the second engaging portion is disposed on a wheel center side of the wheel cover in the radial direction.

A vehicle wheel structure of a fourth aspect of the present disclosure is the vehicle wheel structure of any one of the first to third aspects in which the first engaging portion is engaged with the engaged portion that is provided in the wheel and has a through-hole.

A vehicle wheel structure of a fifth aspect of the present disclosure is the vehicle wheel structure of any one of the first to fourth aspects in which the restricting portion is integrally coupled to the first engaging portion.

A vehicle wheel structure of a sixth aspect of the present disclosure is the vehicle wheel structure of any one of the first to fifth aspects in which the restricting portion is configured to abut against the wheel to restrict an outward relative movement of the wheel cover in the radial direction relative to the wheel.

A vehicle wheel structure of a seventh aspect of the present disclosure is the vehicle wheel structure of any one of the first to sixth aspects in which the wheel cover is formed of a resin material.

A vehicle wheel structure of an eighth aspect of the present disclosure is the vehicle wheel structure of any one of the first to seventh aspects in which the wheel cover attached to the wheel covers at least a part of a surface of the wheel, the surface facing outward of the vehicle.

A vehicle wheel structure of a ninth aspect of the present disclosure is the vehicle wheel structure of the eighth aspect in which the wheel cover includes a plurality of main body constituting members, each of the main body constituting members corresponding to the main body, and a coupling portion that couples the main body constituting members in a circumferential direction of a disk constituting the wheel, with the wheel cover attached to the wheel.

A vehicle wheel structure of a tenth aspect of the present disclosure is the vehicle wheel structure of the ninth aspect in which the coupling portion couples the main body constituting members at a central portion of the disk, with the wheel cover attached to the wheel.

What is claimed is:

1. A vehicle wheel structure comprising:
a wheel that supports a tire and is assembled to a vehicle; and
a wheel cover attached to the wheel, the wheel cover including
a main body,
a pair of engaging portions that is provided on the main body in a radial direction of the wheel and engaged with an engaged portion of the wheel, the engaging portions including a first engaging portion and a second engaging portion, and
a restricting portion provided in the radial direction to restrict a displacement of the first engaging portion, wherein
the wheel cover attached to the wheel is detached from the wheel by displacing the second engaging portion configured not to be restricted in displacement by the restricting portion.

2. The vehicle wheel structure according to claim 1, wherein
the second engaging portion includes
an engaging lug engaged with the engaged portion, and
a pinching portion configured to be operable to displace the engaging lug.

3. The vehicle wheel structure according to claim 1, wherein:
the first engaging portion is disposed on a wheel rim side of the wheel cover in the radial direction; and
the second engaging portion is disposed on a wheel center side of the wheel cover in the radial direction.

4. The vehicle wheel structure according to claim 1, wherein the first engaging portion is engaged with the engaged portion that is provided in the wheel and has a through-hole.

5. The vehicle wheel structure according to claim 1, wherein the restricting portion is integrally coupled to the first engaging portion.

6. The vehicle wheel structure according to claim 1, wherein the restricting portion is configured to abut against the wheel to restrict an outward movement of the wheel cover in the radial direction relative to the wheel.

7. The vehicle wheel structure according to claim 1, wherein the wheel cover is formed of a resin material.

8. The vehicle wheel structure according to claim 1, wherein the wheel cover attached to the wheel covers at least a part of a surface of the wheel, the surface facing outward of the vehicle.

9. The vehicle wheel structure according to claim 8, wherein
the wheel cover includes
a plurality of main body constituting members, each of the main body constituting members corresponding to the main body, and
a coupling portion that couples the main body constituting members in a circumferential direction of a disk constituting the wheel, with the wheel cover attached to the wheel.

10. The vehicle wheel structure according to claim 9, wherein the coupling portion couples a plurality of the main body constituting members at a central portion of the disk, with the wheel cover attached to the wheel.
